(19) United States
(12) Patent Application Publication
(10) Pub. No.: US 2024/0359507 A1
(43) Pub. Date: Oct. 31, 2024

(54) Mixed-Use Heavy-Duty Vehicle Tire with Low Road Noise

(71) Applicant: COMPAGNIE GENERALE DES ETABLISSEMENTS MICHELIN, CLERMONT-FERRAND (FR)

(72) Inventors: Xavier NEAU, Clermont-Ferrand Cedex 9 (FR); Benjamin QUANTINET, Clermont-Ferrand Cedex 9 (FR); Romain BERTHIER, Clermont-Ferrand Cedex 9 (FR)

(21) Appl. No.: 18/565,895

(22) PCT Filed: May 23, 2022
(86) PCT No.: PCT/FR2022/050976

§ 371 Date: Nov. 30, 2023

(30) Foreign Application Priority Data
May 31, 2021 (FR) FR2105687

(51) Int. Cl. B60C 11/11; B60C 11/03

(52) U.S. Cl. CPC B60C 11/11; B60C 11/0302; B60C 2200/06

(57) ABSTRACT

A tire (1) for a heavy goods vehicle having a tread (2) with low road noise. Two consecutive rows of blocks are in the form of a chevron (6) of the tread (2) and are separated by a transverse cut-out in the form of a chevron (52) which extends continuously from one edge of the tread to the other so that the leading or trailing edges (41) of the blocks (4) are positioned in the same line (L) and any transverse cut-out in the form of a chevron (52) has a mean line (Lt) which is constituted by two branches (Lt1, Lt2) which each form, with the axial direction (YY′), a mean angle (B1, B2) at a minimum of 15° and at a maximum of 55°.

The present invention relates to a tire for a heavy goods vehicle which is intended for mixed use, that is to say, which is capable of travelling on tarred or stony ground, and relates more specifically to the tread thereof, comprising a tread pattern which generates a low road noise.

A tread, which is constituted by at least one rubber-based material, is the gripping wear part of the tire, which part is located at the periphery thereof and is intended to be worn when it come into contact with an underlying surface via a travel surface and to ensure the grip of the tire during its contact with the ground.

A tread most often comprises a tread pattern which is a combination of cut-outs, or hollow portions, and relief elements, of the block type or rib type. A tire tread for mixed use must ensure the grip of the tire on hard or soft ground which may be covered with water, mud or snow. In particular for use on muddy ground, it must ensure adequate traction. Furthermore, when used on stony ground, the tread must be capable of ejecting the stones which are capable of becoming trapped in the hollows thereof, and/or must comprise protection means with respect to these stones in order to prevent their migration toward the interior of the tire which is capable of bringing about premature deterioration of the tire.

The geometric features described in this document are defined in a cylindrical reference system which is linked with the tire. Conventionally, the circumferential or longitudinal direction is the rotation direction of the tire, the axial or transverse direction is the direction parallel with the rotation axis of the tire and the radial direction is a direction perpendicular to the rotation axis of the tire.

Any cut-out has a mean line which is not necessarily rectilinear and which may be undulating or zig-zag-like, and which has a mean circumferential or transverse direction. Generally, a cut-out is said to be circumferential when the mean line thereof has a mean circumferential direction, that is to say, it forms with the circumferential direction a mean angle less than 45°. A cut-out is said to be transverse when the mean line thereof has a mean transverse direction, that is to say, it forms with the axial direction a mean angle of a maximum of 45°.

The cut-outs of a tread are generally classified in two categories: wide cut-outs, referred to as grooves, and narrow cut-outs, referred to as incisions. The grooves delimit relief elements which can become deformed without coming into contact with each other when the tread moves into the contact surface with the ground. It should be noted that the grooves which are the widest cut-outs are the most likely to retain the largest stones which are capable of migrating and degrading the tread. The incisions, which are less wide than the grooves, have such a width that the walls of the facing relief elements which delimit them come into contact with each other at least partially when the tread moves in the contact surface. In order to determine the possibility or not of contact between the walls of material which delimit a cut-out, the conditions of load and pressure which are applied to the tire are generally those specified, for example, by the European Standards of the “European Tire and Rim Technical Organization” or “E.T.R.T.O” in its “Standards Manual 2020—Commercial Vehicle Tires”.

The relief elements of a tread of a mixed-use tire are generally blocks which are organized, most often, but not necessarily, in circumferential rows which are juxtaposed in the axial direction. The distribution of the blocks may be symmetrical or asymmetrical relative to a central circumferential plane which is perpendicular to the rotation axis of the tire and which passes via the center of the tread. A block comprises a contact face which is positioned in the travel surface and which is intended to come completely into contact with the ground, a leading face, which intersects with the travel surface and the edge of intersection of which therewith is intended to come into contact with the ground first, a drainage face which intersects with the travel surface and the edge of intersection of which therewith is intended to come into contact with the ground last, and two lateral faces.

It is known that a tire for mixed use which is intended in particular to be fitted on a driving axle and which has a tread which comprises an arrangement of blocks which are separated from each other by means of circumferential and/or transverse grooves, generates road noise. This is because the leading and trailing edges of the blocks, when they enter and leave the contact surface of the tire with the ground, generate noise emissions, the total of which constitutes a frequency spectrum, generating a greater or lesser overall noise level.

Standards, which are generally specific to the relevant geographic zones, have imposed reductions on the overall noise emitted by tires: which requires in particular a development of the design of tire treads. By way of example, document WO 201504150 A1 describes a tire for a heavy goods vehicle, the road noise level of which is reduced, without affecting other performance levels of the tire, such as wear and grip in terms of traction. More specifically, this document describes a tread having an asymmetric tread pattern, relative to a circumferential plane which separates the tread into a left portion and a right portion, respectively, in the circumferential travel direction, the tread comprising at least five circumferential rows of blocks which are distributed at one side and the other of the circumferential plane. The blocks are arranged in such a manner that the leading edges of all the blocks are offset relative to each other in the circumferential travel direction in an appropriate manner so that the leading edges successively come into contact during travel and the movement into contact of these leading edges occurs alternately at one side and the other of the circumferential separation plane in a type of back and forth manner.

The inventors have set themselves the objective of reducing the road noise of a tire which is intended to be fitted more specifically in a driving axle of a mixed-use heavy goods vehicle, the tire having a tread which comprises an appropriate arrangement of blocks which transmit a reduced road noise, whilst ensuring sufficient traction and a good capability of the tread for limiting the retention of stones in the cut-outs thereof.

This objective has been achieved with a tire for a heavy goods vehicle, comprising a tread which is intended to come into contact with the ground via a travel surface, having a width W and comprising an arrangement of blocks in pairs which are separated by cut-outs,
the arrangement of blocks being constituted, in a circumferential direction of the tire, by a circumferential distribution of rows of blocks in the form of a chevron so that all the chevrons are orientated in the travel direction of the tire and have their respective tips, which are positioned in the same plane, perpendicular to the rotation axis of the tire,
each row of blocks in the form of a chevron extending from one edge of the tread to the other and being constituted, in an axial direction of the tire by a juxtaposition of blocks,
the blocks of the same row of blocks in the form of a chevron being separated in pairs by a circumferential cut-out which has a mean line which forms, with the circumferential direction, a mean angle less than 45°,
two consecutive rows of blocks in the form of a chevron being separated by a transverse cut-out in the form of a chevron which extends continuously from one edge of the tread to the other so that the leading or trailing edges of the blocks which delimit, in the travel surface, the transverse cut-out in the form of a chevron are positioned in the same line,
and any transverse cut-out in the form of a chevron having a mean line which is constituted by two branches which each form, with the axial direction, a mean angle at a minimum of 15° and at a maximum of 55°.

Substantially, the tread of a tire according to the invention comprises, in the circumferential direction of the tire, an alternating arrangement of rows of blocks and transverse cut-outs, which is in the form of a chevron and which extends transversely from one edge to the other of the tread.

A row of blocks in the form of a chevron is a juxtaposition of blocks in the axial direction, also referred to as the transverse direction, the blocks being arranged in two directions which form an arrow. The tip of the chevron, that is to say, the tip of the arrow, is a geometric point or a connection zone of the two branches of the chevron which are not necessarily reduced to a tip.

The blocks of the same row of blocks in the form of a chevron are separated in pairs by a circumferential cut-out which has a mean line which forms, with the circumferential direction, a mean angle less than 45°. Advantageously, the mean angle of the mean line of a circumferential cut-out is at a maximum 15°.

A transverse cut-out in the form of a chevron, which separates two consecutive rows of blocks in the form of a chevron, extends continuously from one edge of the tread to the other so that the leading or trailing edges of the blocks which delimit, in the travel surface, the transverse cut-out in the form of a chevron, are positioned in the same line. In other words, the leading or trailing edges of these blocks are positioned in continuation of each other, remaining in the same line, which is itself in the form of a chevron. Consequently, at one side and the other of the same circumferential cut-out, there is no circumferential offset of the blocks which delimit the circumferential cut-out.

A transverse cut-out in the form of a chevron is a cut-out, the mean line of which is constituted by two branches which each form, with the axial direction, a mean angle not equal to zero and which join each other so as to form an arrow. The mean angle of a branch is the angle formed by the straight line which connects the two ends of the branch with the axial direction. In the case of the invention, this mean angle is at a minimum 15° and at a maximum 55°.

This alternating arrangement of rows of blocks and transverse cut-outs, in the form of a chevron, each branch of which has a mean direction which forms, with the axial direction, a mean angle at a minimum of 15° and at a maximum of 55°, enables at the same time noise to be reduced, traction to be improved and retention of stones to be limited.

On the one hand, a minimum mean angle of 15°, for each branch of the chevron, enables the inlets of the leading edges of the blocks of the same circumferential row in contact with the ground to be offset significantly, which enables a reduction of the road noise emitted. On the other hand, a maximum mean angle of 55°, for each branch of the chevron, makes it possible to have in the surface a cumulative length of edges of the blocks of the same circumferential row, ensuring good grip of the tire, in particular in terms of traction. Furthermore, the continuity of the transverse cut-outs avoids having angular transition portions which are capable of retaining stones.

Preferably, the mean angle of each branch of the mean line of any transverse cut-out in the form of a chevron, relative to the axial direction, is at a minimum 25°. The higher this mean angle is, the more significant is the offset between the inlets of the leading edges of the blocks of the same circumferential row in contact with the ground and the more the road noise is reduced.

Again preferably, the mean angle of each branch of the mean line of any transverse cut-out in the form of a chevron relative to the axial direction is at a maximum 40°. The smaller this mean angle is, the greater is the cumulative length of edges of blocks in the contact surface and therefore the better the grip is in terms of traction.

Advantageously, each branch of the mean line of any transverse cut-out in the form of a chevron has a concave curvilinear shape so that the center of curvature at any point of the branch is positioned, in the travel direction of the tire, in front of the branch. This concave shape has a substantially aesthetic purpose.

According to a preferred variant of the concave shape of the chevron-like branches described above, the radius of curvature R at any point of the curvilinear concave branch is at least equal to the width W of the tread. Such a radius of curvature avoids having an inclination of the mean line of the transverse cut-out which is too small, typically less than 15°, at the edge of the tread, or too high, typically greater than 55°, at the center of the tread.

Advantageously, any transverse cut-out in the form of a chevron has a maximum depth D2 and a mean width W2 so that the ratio W2/D2 is at least 20%, preferably at least 30%. The maximum depth D2 is the radial distance between the travel surface and the radially innermost point of the cut-out. The mean width W2 is defined as being the mean of the widths over the entire depth of the cut-out, this generally having walls which form an angle, with a radial direction, which is referred to as the clearance angle. A ratio W2/D2 which is at least 20% characterizes a cut-out of the groove type, the walls of which may become deformed without coming into contact with each other when the tread moves into the contact surface with the ground, and has an advantage in terms of noise reduction. A ratio W2/D2 which is at least 30% characterizes a wide groove which is effective with respect to the discharge of water and mud when travelling on soft ground, and therefore with respect to grip, in particular on soft ground.

Also advantageously, any transverse cut-out in the form of a chevron has a maximum depth D2 and a mean width W2 so that the ratio W2/D2 is at the most 150%. Beyond 150%, the total volume of transverse cut-outs become unfavorable with respect to the wear limits of the tire since correlatively it brings about a significant reduction of the volume of material to be worn.

Again advantageously, any transverse cut-out in the form of a chevron comprises a protuberance at the base of the cut-out, in the region of the tip of the chevron-like shape. The presence of a protuberance at the base of the transverse cut-out protects the base of the cut-out from any aggressive action from stones trapped in the cut-out. A positioning of this protuberance at the tip of the chevron is particularly effective since this angled portion is particularly favorable for the retention of stones.

Advantageously, any circumferential cut-out D1 has a maximum depth D1 and a mean width W1 so that the ratio W1/D1 is at least 20%. As seen above, a ratio W1/D1 which is at least 20% characterizes a cut-out of the groove type, the walls of which may become deformed without coming into contact with each other when the tread moves in the contact surface with the ground, and has an advantage in terms of noise reduction.

However, a ratio W1/D1 less than 20% which is characteristic of an incision, the walls of which are capable of coming into contact, may also be envisaged for a circumferential cut-out. This is because the presence of circumferential incisions is advantageous with respect to the compromise between the service-life in terms of wear, which is promoted by a greater volume of material to be worn, and blocks which are less deformable, and the resistance to travel, which is promoted by less deformable blocks.

Also in an advantageous manner, any circumferential cut-out has a maximum depth D1 and a mean width W1 so that the ratio W1/D1 is at the most 150%. Beyond 150%, the total volume of circumferential cut-outs becomes unfavorable with respect to the wear life of the tire since, correlatively, it brings about a significant reduction of the volume of material to be worn.

Preferably, the circumferential plane which contains the respective tips of the rows of blocks in the form of a chevron is non-median and axially positioned relative to the central circumferential plane, which is perpendicular to the rotation axis of the tire and which extends through the center of the tread, at an axial distance Yp which is at the most 20%, preferably at the most 10% of the width W of the tread. An asymmetry of the tread enables a desynchronization of the impacts on the ground to be obtained between a right portion and a left portion of the tread, which contributes to a noise reduction. However, this asymmetry must be limited in order to retain balanced operation of the tread in terms of wear, grip and behavior of the tire.

According to a specific embodiment, at least some of the blocks of the tread comprise cut-outs of the incision type, which have a ratio W3/D3 less than 20%, W3 and D3 being the mean width and depth of the incisions, respectively. Preferably, these incisions are transverse, that is to say, have a mean line which forms with the axial direction a mean angle of a maximum of 45°. Again preferably, only the blocks included in a central portion of the tread which are symmetrical with respect to the center plane and which have an axial width of at the most 75% of the width W of the tread comprise incisions. The central portion is intended to be understood to be a tread portion which does not open at the edges of the tread and which is included between two lateral portions which each open at an edge of the tread.

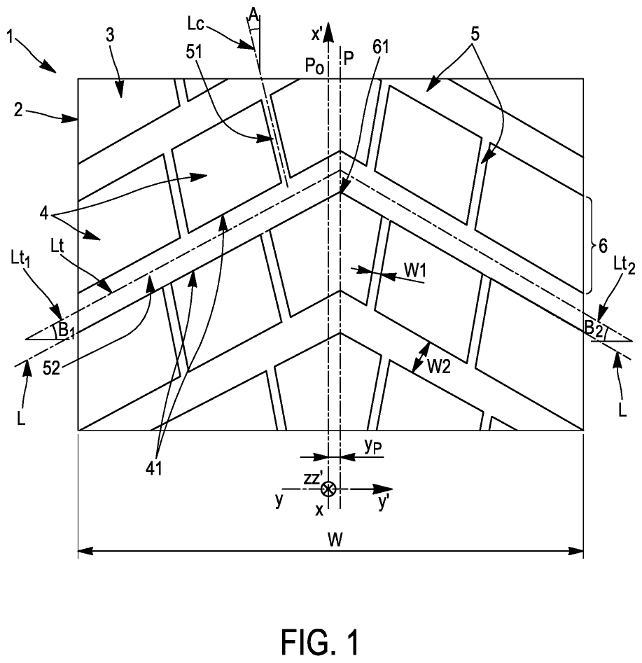

The features of the invention are illustrated in the following FIGS. 1 to 4 which are schematic and not true to scale:

FIG. 1: shows a plan view of a tread according to a first embodiment of the invention,

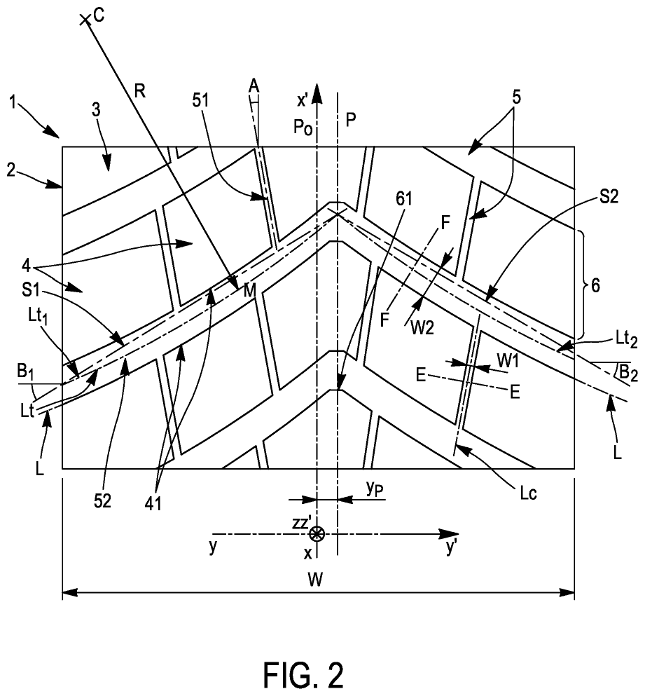

FIG. 2: shows a plan view of a tread according to a second embodiment of the invention,

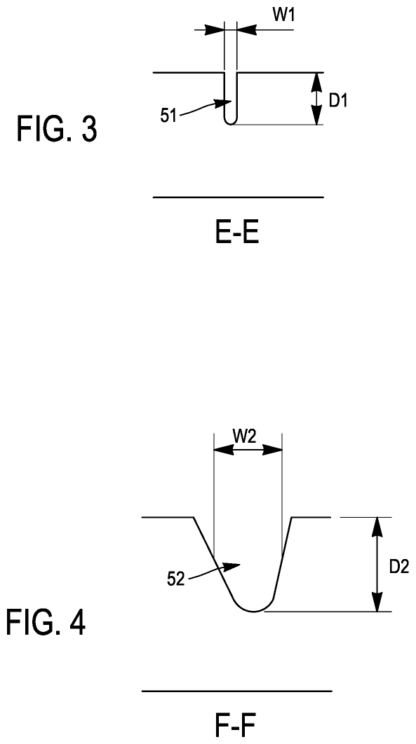

FIG. 3: shows a sectioned view of a circumferential cut-out,

FIG. 4: shows a sectioned view of a transverse cut-out.

FIG. 1 is a plan view of a tread 2 of a tire 1 for a heavy goods vehicle according to a first embodiment of the invention with rectilinear chevron-like branches. The tread 2, which is intended to come into contact with the ground via a travel surface 3, has a width W and comprises an arrangement of blocks 4 in pairs which are separated by cut-outs 5. The arrangement of blocks 4 is constituted, in a circumferential direction XX′ of the tire, by a circumferential distribution of rows of blocks in the form of a chevron 6 so that all the chevrons are orientated in the travel direction XX′ of the tire and have their respective tips 61, which are positioned in FIG. 1, in the same non-median circumferential plane P which is perpendicular to the rotation axis of the tire and which does not extend through the center of the tread 2. The non-median circumferential plane P is axially positioned, with respect to the median circumferential plane P0 which is perpendicular to the rotation axis of the tire and which extends through the center of the tread 2, at an axial distance Yp. According to the specific embodiment illustrated, the non-median circumferential plane P is axially positioned, relative to the median circumferential plane P0, at an axial distance Yp which is at the most 20%, preferably at most 10% of the width W of the tread. Each row of blocks in the form of a chevron 6 extends from one edge of the tread to the other and is constituted, in an axial direction YY′ of the tire, by a juxtaposition of blocks 4. The blocks 4 of the same row of blocks in the form of a chevron 6 are separated in pairs by a circumferential cut-out 51 which has a mean width W1 and which has a mean line Lc which forms, with the circumferential direction XX′, a mean angle A less than 45°. According to the invention, two consecutive rows of blocks in the form a chevron 6 are separated by a transverse cut-out in the form of a chevron 52 which extends continuously from one edge of the tread to the other so that the leading or trailing edges 41 of the blocks 4 which delimit, in the travel surface 3, the transverse cut-out in the form of a chevron 52 are positioned in the same line L, and any transverse cut-out in the form of a chevron 52 has a mean line Lt which is constituted by two branches (Lt1, Lt2) which each forms, with the axial direction YY′, a mean angle (B1, B2) of a minimum of 15° and a maximum of 55°. In this instance, the mean angle (B1, B2) of each rectilinear branch (Lt1, Lt2) is equal to the constant angle formed by the rectilinear branch (Lt1, Lt2) with the axial direction YY′.

FIG. 2 is a plan view of a tread of a tire for a heavy goods vehicle according to a second embodiment of the invention with curvilinear chevron-like branches. FIG. 2 differs from FIG. 1 as a result of the concave curvilinear shape of the mean line of each branch (Lt1, Lt2) of the mean line of any transverse cut-out in the form of a chevron 52 so that the center of curvature C at any point M of the branch (Lt1, Lt2) is positioned, in the travel direction of the tire, in front of the branch (Lt1, Lt2). Preferably, the radius of curvature R at any point M of the branch (Lt1, Lt2) of concave curvilinear shape is at least equal to the width W of the tread 2. In this instance, the mean angle (B1, B2) of each curvilinear branch (Lt1, Lt2) is equal to the angle formed by the straight line (S1, S2) which extends through the ends of the curvilinear branch (Lt1, Lt2) with the axial direction YY′. In the case of FIG. 1 described above, the rectilinear branches (Lt1, Lt2) are aligned with the straight lines (S1, S2).

FIG. 3 is a sectioned view of a circumferential cut-out 51 of a tread according to the invention, as illustrated in FIG. 2. This view is taken along a plane of section E-E of FIG. 2, which is perpendicular to the mean line Lc of the circumferential cut-out 51. Advantageously, the circumferential cut-out 51 has a maximum depth D1 and a mean width W1 so that the ratio W1/D1 is at least 20%, preferably at least 30%. Again advantageously, the ratio W1/D1 is at the most 150%.

FIG. 4 is a sectioned view of a transverse cut-out in the form of a chevron 52 of a tread according to the invention, as illustrated in FIG. 2. This view is taken along a plane of section F-F of FIG. 2, which is perpendicular to the branch Lt2 of the mean line of the transverse cut-out in the form of a chevron 52. Advantageously, the transverse cut-out in the form of a chevron 52 has a maximum depth D2 and a mean width W2 so that the ratio W2/D2 is at least 20%. Again advantageously, the ratio W2/D2 is at the most 150%.

The embodiment of FIG. 2 has more specifically been studied by the inventors in terms of the tire dimension 315/80R22.5, for a tire for mixed use which is intended to be fitted on a driving axle. This tire, from the point of view of a standard, has a load capacity of 3350 kg for an inflation pressure of 8.5 bar.

Table 1 below sets out the features of the tread tested:

TABLE 1

| Features | Values | |
|---|---|---|
| Mean angle (B1, B2) of the branches (Lt1, Lt2) of the | 30° | |
| mean line Lt of a transverse cut-out in the form of | | |
| a chevron 52 relative to the axial direction YY′ | | |
| Mean radius of curvature (Lt1, Lt2) of the mean line | 600 | mm |
| of a transverse cut-out in the form of a chevron 52 | | |
| Mean depth D2 of a transverse cut-out in the form | 22 | mm |
| of a chevron 52 | | |
| Mean width W2 of a transverse cut-out in the form | 12 | mm |
| of a chevron 52 | | |
| Ratio W2/D2 of a transverse cut-out in the form | 55% | |
| of a chevron 52 | | |
| Mean angle A of a circumferential cut-out 51 | 10° | |
| relative to the circumferential direction XX′ | | |
| Maximum depth D1 of a circumferential cut-out 51 | 18 mm (center)/ | |
| | 14 mm (edge) | |
| Mean width W1 of a circumferential cut-out 51 | 4 | mm |
| Ratio W1/D1 of a circumferential cut-out 51 | 22% (center)/ | |
| | 29% (edge) | |
| Width W of the tread | 250 | mm |
| Axial distance Yp of the non-median circumferential | 10 | mm |
| plane P relative to the median circumferential plane | | |
| P0 | | |

| | |
|---|---|
| Ratio Yp/W | 4% |

An external road noise test was carried out in accordance with the regulation BCE R117 published by the European Economic Commission and showed a sound gain of −2 dBA compared with the current threshold of 76 dBA imposed on a tire of the class C3 of the Traction category and referred to as 3PMSF (3 Peak Mountain Snow Flake: criteria of grip on snow and on black ice).

1. A tire for a heavy goods vehicle, comprising a tread which is intended to come into contact with the ground via a travel surface, having a width W and comprising an arrangement of blocks in pairs which are separated by cut-outs,
the arrangement of blocks being constituted, in a circumferential direction (XX′) of the tire, by a circumferential distribution of rows of blocks in the form of a chevron so that all the chevrons are orientated in the travel direction (XX′) of the tire and have their respective tips, which are positioned in the same circumferential plane (P), perpendicular to the rotation axis of the tire,
each row of blocks in the form of a chevron extending from one edge of the tread to the other and being constituted in an axial direction (YY′) of the tire by a juxtaposition of blocks,
the blocks of the same row of blocks in the form of a chevron being separated in pairs by a circumferential cut-out which has a mean line (Lc) which forms, with the circumferential direction (XX′), a mean angle (A) less than 45°,
two consecutive rows of blocks in the form of a chevron are separated by a transverse cut-out in the form of a chevron which extends continuously from one edge of the tread to the other so that the leading or trailing edges of the blocks which delimit, in the travel surface, the transverse cut-out in the form of a chevron are positioned in the same line (L), and wherein any transverse cut-out in the form of a chevron has a mean line (Lt) which is constituted by two branches (Lt1, Lt2) which each form, with the axial direction (YY′), a mean angle (B1, B2) at a minimum of 15° and at a maximum of 55°.

2. The tire as claimed in claim 1, wherein the mean angle (B1, B2) of each branch (Lt1, Lt2) of the mean line (Lt) of each transverse cut-out in the form of a chevron, relative to the axial direction (YY′), is at a minimum 25°.

3. The tire as claimed in claim 1, wherein the mean angle (B1, B2) of any branch (Lt1, Lt2) of the mean line (Lt) of each transverse cut-out in the form of a chevron, relative to the axial direction (YY′), is at a maximum 40°.

4. The tire as claimed in claim 1, wherein each branch (Lt1, Lt2) of the mean line (Lt) of any transverse cut-out in the form of a chevron has a concave curvilinear shape so that the center of curvature (C) at any point (M) of the branch (Lt1, Lt2) is positioned, in the travel direction of the tire, in front of the branch (Lt1, Lt2).

5. The tire as claimed in claim 4, wherein the radius of curvature R at any point (M) of the branch (Lt1, Lt2) of concave curvilinear shape is at least equal to the width W of the tread.

6. The tire as claimed in claim 1, wherein any transverse cut-out in the form of a chevron has a maximum depth D2 and a mean width W2 so that the ratio W2/D2 is at least 20%, preferably at least 30%.

7. The tire as claimed in claim 1, wherein any transverse cut-out in the form of a chevron has a maximum depth D2 and a mean width W2 so that the ratio W2/D2 is at the most 150%.

8. The tire as claimed in claim 1, wherein any transverse cut-out in the form of a chevron comprises a protuberance at the base of the cut-out, in the region of the tip of the chevron-like shape.

9. The tire as claimed in claim 1, wherein any circumferential cut-out has a maximum depth D1 and a mean width W1 so that the ratio W1/D1 is at least 20%.

10. The tire as claimed in claim 1, wherein any circumferential cut-out has a maximum depth D1 and a mean width W1 so that the ratio W1/D1 is at the most 150%.

11. The tire as claimed in claim 1, wherein the circumferential plane (P), which contains the respective tips (61) of the rows of blocks in the form of a chevron (6) is non-median and axially positioned relative to the central circumferential plane (P0), which is perpendicular to the rotation axis of the tire and which extends through the center of the tread (2), at an axial distance Yp which is at the most 20%, of the width W of the tread.

12. The tire as claimed in claim 1, wherein the circumferential plane (P), which contains the respective tips of the rows of blocks in the form of a chevron is non-median and axially positioned relative to the central circumferential plane (P0), which is perpendicular to the rotation axis of the tire and which extends through the center of the tread (2), at an axial distance Yp which is at the most 10% of the width W of the tread
